(19) United States
(12) Patent Application Publication
(10) Pub. No.: US 2005/0051650 A1
(43) Pub. Date: Mar. 10, 2005

(54) Paper shredding vehicle

(76) Inventor: Katsuaki Watanabe, Osaka (JP)

Correspondence Address: THOMPSON HINE L.L.P., 2000 COURTHOUSE PLAZA , N.E., 10 WEST SECOND STREET, DAYTON, OH, 45402, US

(21) Appl. No.: 10/930,482

(22) Filed: Aug. 31, 2004

(30) Foreign Application Priority Data
Sep. 5, 2003 (JP) 2003-314481

(51) Int. Cl. B02C 21/02

(52) U.S. Cl. 241/101.741

(57) ABSTRACT

A vehicle with a paper shredder including a driver's cab section, a loading platform section and a box-like container mounted on the loading platform defining a closed space. The container is partitioned, in the order in a direction from the front to the back of the vehicle, into a shredding operation chamber where an operator works, a shredder chamber into which papers are introduced for shredding, and a shred storage chamber for compacting and collecting the shreds. The shredder chamber includes a paper introduction port opened to the shredding operation chamber, a shredder arranged below the paper introduction port including two axis shredding screw blades below the paper introduction port, and a conveyance and compaction unit including a screw conveyor for conveying shredded strips to the shred storage chamber.

### BACKGROUND

This application claims priority to Japanese Patent Application No. 2003-314481 filed on Sep. 5, 2003, the contents of which is hereby incorporated by reference.

The present invention relates to a vehicle for shredding and crushing unnecessary but still confidential documents. More particularly, the present invention relates to a vehicle with a paper shredder that preserves confidentiality and achieves high transport efficiency in the transportation of shredded documents in the course of collecting, storing confidential documents, and transporting the confidential documents to a paper manufacturing plant for recycling.

Conventionally, documents having high confidentiality are individually shredded by a shredder in each office. For example, a vast amount of documents bearing information relating to personal privacy are generated in banking institutions and insurance companies. Since space available for storage of documents is limited, such documents are shredded after a predetermined retention period of time. However, shredded documents are bulky, typically 10 times as large as the original volume of the documents. For this reason, transportation costs for transporting shredded documents to a paper manufacturing company for dissolving the shreds for recycling are too high, and the recycling business is not profitable. If the shredded documents are compacted to some degree, the recycling business becomes profitable.

Recycling of used paper, including confidential documents, is required from the standpoint of protecting the environment. Paper shredding vehicles have been proposed. The paper shredding vehicle transports confidential documents to a paper manufacturing company with confidentiality maintained and dissolves the documents for recycling. For example, a vehicle with a paper shredder disclosed in Japanese Utility Model No. 3018367 is not necessarily applied to the processing of confidential documents. According to this disclosure, a cargo room of a truck includes a crusher for crushing paper, a debris collector for collecting debris resulting from a crushing operation, and an electric generator for supplying power to a motor that drives the crusher. A paper processing vehicle disclosed in Japanese Unexamined Patent Application Publication No. 10-305902 includes a paper processing apparatus. The paper processing apparatus includes a shredder for shredding paper and a tray for receiving shreds discharged from the shredder.

Japanese Unexamined Patent Application Publication No. 2002-179202 discloses a vehicle with a paper shredder that accommodates shreds efficiently. The vehicle with a paper shredder includes a vehicle body cruising and having a driving section at the front thereof, a shredder, arranged on the vehicle body, for shredding introduced paper, and a container into which shreds shredded by the shredder are pushed. A garbage truck disclosed in Japanese Unexamined Patent Application Publication No. 2003-40402 includes a garbage container arranged on a loading platform behind a driver's cab and a shredder which is arranged behind the garbage container for shredding unnecessary sheets and discharging shreds. Also arranged below the garbage container is a garbage conveyor which conveys the shreds discharged from the shredder frontward.

The vehicle with a paper shredder disclosed in Japanese Utility Model No. 3018367 is used in processing general papers and is not intended to recycle used sheets of paper. The paper processing vehicle disclosed in Japanese Unexamined Patent Application Publication No. 10-305902 includes a paper processing apparatus which is intended to recycle resources in a wide range, requires sorting and collecting means for sorting and collecting shreds and is complex in structure leading to high manufacturing costs. Debris must be packed in bags and packing efficiency of the debris is low. The vehicle with a paper shredder disclosed in Japanese Unexamined Patent Application Publication No. 2002-179202 includes the container for directly holding the shreds. Although this kind of vehicle includes a conveyor, a pusher and a compactor, its structure is complex, leaving a problem of high manufacturing costs. In the garbage truck disclosed in Japanese Unexamined Patent Application Publication No. 2003-40402, the rear bottom portion of a discharge plate rises frontward while the rear top portion of the discharge plate rises backwardly to enhance packing efficiency of the debris. But the packing efficiency is still low.

### SUMMARY

The present invention has been developed in view of the above problems and it is an object of the present invention to provide a vehicle with a paper shredder which maintains confidentiality while shredding confidential documents, improves compaction ratio of shreds and provides a high transportation efficiency.

According to one embodiment of the present invention, a self-propelled vehicle with a paper shredder includes a driver's cab section, a loading platform section and a box-like container mounted on the loading platform defining a close space having a predetermined size. The box-like container is partitioned in the order in a direction from the front to the back of the vehicle into a shredding operation chamber where an operator works, a shredder chamber into which papers are introduced for shredding, and a shred storage chamber for compacting and collecting the shreds.

The shredder chamber may include a paper introduction port opened to the shredding operation chamber, a shredder arranged below the paper introduction port including two axis shredding screw blades below the paper introduction port, and a conveyance and compaction unit including a screw conveyor for conveying shredded strips to the shred storage chamber. The conveyance and compaction unit having a discharge port opened at the level of the floor of the shred storage chamber.

According to a second embodiment, a drive shaft of the screw conveyor is tilted up backward at an angle within a range from 0 to 5 degrees with respect to the floor of the shredder chamber.

According to a third embodiment, the shredder chamber includes an engine, the engine applying pressure to a hydraulic pump which drives hydraulic motors for the shredding screw blades and the screw conveyor.

According to a fourth embodiment, an engine of the vehicle applies pressure to a hydraulic pump, thereby driving hydraulic motors for the shredding screw blades and the screw conveyor.

According to a fifth embodiment, at least four internal faces of the shred storage chamber are covered with reinforcement panels having flat surfaces.

According to a sixth embodiment, the floor of the shred storage chamber is covered with a single sheet of steel.

According to a seventh embodiment, the entire floor of the shred storage chamber includes a belt conveyor.

Since the vehicle with a paper shredder of one embodiment of the present invention goes to a location of confidential documents to shred them, the confidentiality of the documents is securely protected. Since the container on the loading platform provides a closed space, nobody can view the documents from outside. Since the document papers are not blown away by sudden wind, confidentiality is assured.

Since the internal space of the container is partitioned into the shredding operation chamber, the shredder chamber, and the shred storage chamber in the order in a direction from the front of the vehicle, a heavy machine section is installed at the approximate center of the vehicle. The vehicle is thus well balanced even when the vehicle is running.

The conveyance and compaction unit has the discharge port opened at the level of the floor of the shred storage chamber, and the driving shaft of the screw conveyor is tilted up in a backward direction at an angle within a range from 0 to 5 degrees with respect to the floor of the shredder chamber. This arrangement enhances the effect of compaction of the strips in horizontal and vertical directions. Compaction forces in the horizontal and vertical directions are thus effectively applied.

The shredder chamber and the conveyance and compaction unit may be driven by the independent engine or directly by a vehicle's engine.

Since the four walls of the shred storage chamber are constructed of reinforcement flat panels, the strips are smoothly discharged and condensation is allowed to drop downward easily.

Since the floor of the shred storage chamber is covered with a sheet of steel, the shreds are easily discharged using a forklift. If the floor is constructed of the belt conveyor, the shreds are easily discharged.

### BRIEF DESCRIPTION OF THE DRAWINGS

FIG. 1 (a) is a side view of a vehicle with a paper shredder of one embodiment of the present invention;

FIG. 1 (b) is a plan view of the vehicle of FIG. 1 (a);

FIG. 2 (a) is a front view of the shredder chamber;

FIG. 2 (b) is a side view of the shredder chamber of FIG. 2 (c);

FIG. 2 (c) is a plan view of the shredder chamber of FIG. 2 (a);

FIG. 3 (a) is a front view of another shredder chamber;

FIG. 3 (b) is a side view of the shredder chamber of FIG. 3 (a);

FIG. 3 (c) is a plan view of the shredder chamber of FIG. 3 (a).

### DETAILED DESCRIPTION

A vehicle with a paper shredder 1 according to the present invention is described below with reference to the drawings.

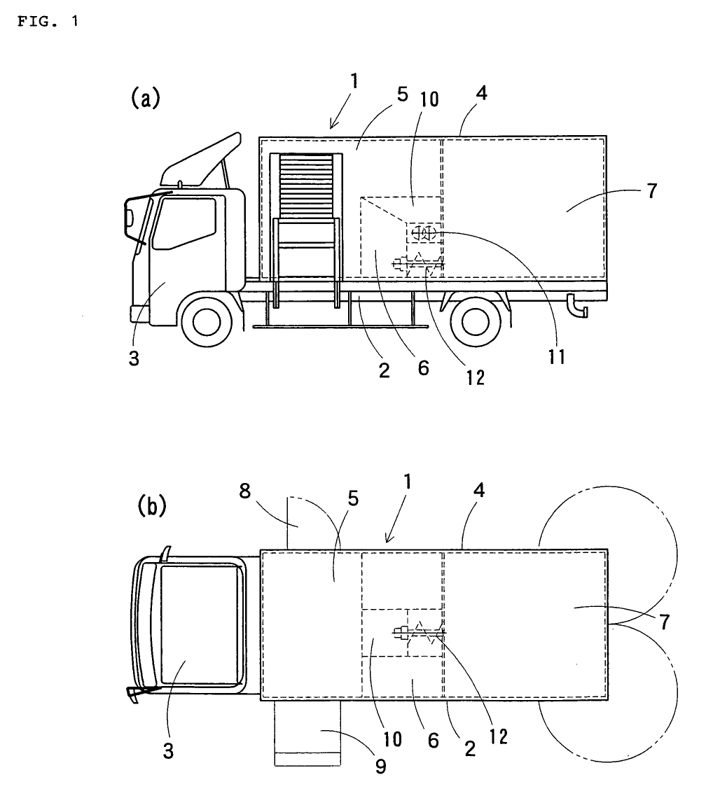

FIG. 1 (a) is a side view of the vehicle with a paper shredder of a first embodiment of the present invention and FIG. 1 (b) is a plan view of the vehicle. As shown, the vehicle 1 includes a loading platform 2 on the back portion thereof and a driver's cab section 3 on the front portion thereof. A box-like vehicle body 4 defining a closed space having a predetermined size is mounted on the loading platform 2. The internal space of the vehicle body 4 is partitioned into three sections, namely, a shredding operation chamber 5, a shredder chamber 6 and a shred storage chamber 7.

The shredding operation chamber 5 provides space within which operators work and has a side door 8 on an entrance on the right-hand side thereof viewed from the front of the vehicle and a side lift 9 on the left-hand side thereof for introducing papers (such as confidential documents).

The shredder chamber 6 includes a paper introduction section 10 facing the shredding operation chamber 5, a shredder 11 including two-axis shredding screw blades below the paper introduction section 10 and a conveyance and compaction unit 12, containing a screw conveyor, arranged below the shredder 11 for collecting shredded strips into the shred storage chamber. The discharge port of the conveyance and compaction unit 12 is opened at the level of the floor of the shred storage chamber 7. The drive shaft of the screw conveyor is tilted up backward at an angle within a range of from 0 to 5 degrees with respect to the floor of the shredder chamber.

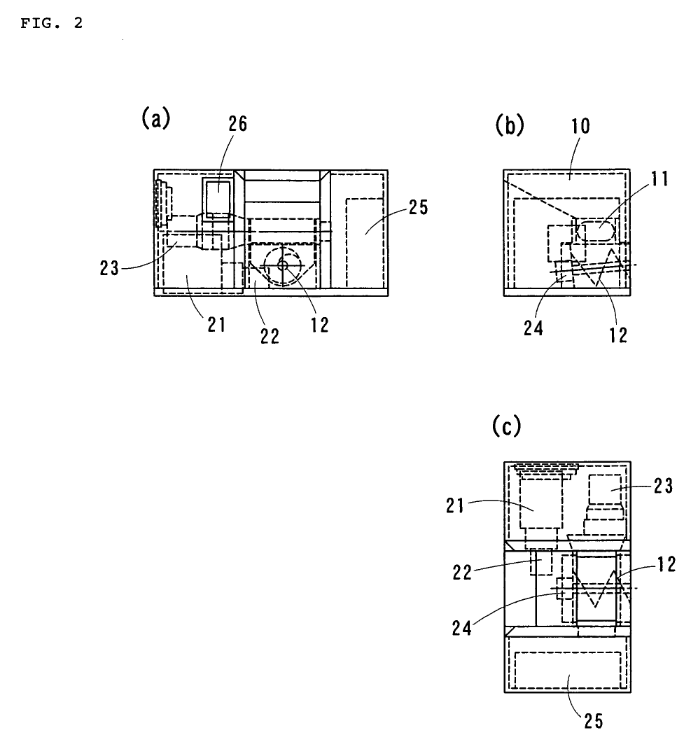

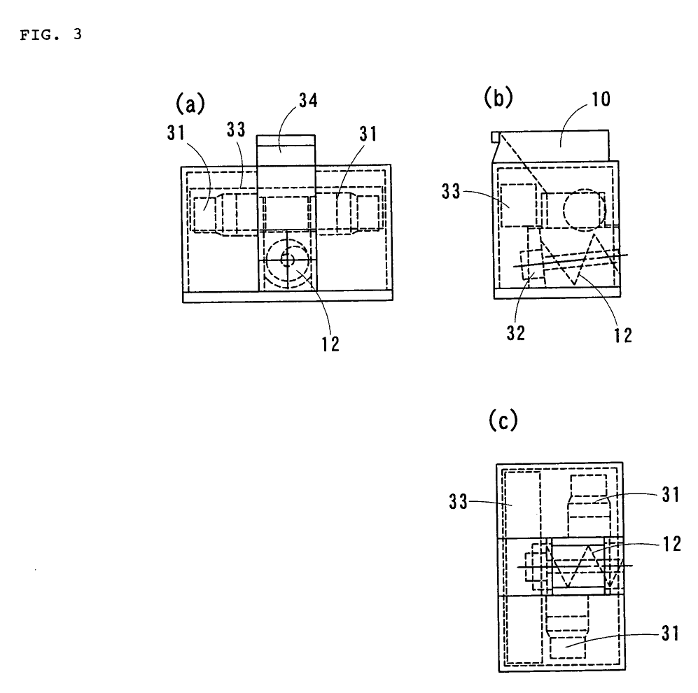

A drive method of the shredder 11 and the conveyance and compaction unit 12 is described below. FIGS. 2 (a)-2 (c) illustrate a shredder chamber using an independent engine, and FIGS. 3 (a)-3 (c) illustrate a shredder chamber using an engine of the vehicle.

FIG. 2 (a) is a front view of the shredder chamber, FIG. 2 (b) is a side view of the shredder chamber, and FIG. 2 (c) is a plan view of the shredder chamber. The shredder chamber includes an engine 21, a hydraulic pump 22, a hydraulic motor 23 for shredding blades, a hydraulic motor 24 for the screw conveyor, an oil tank 25 and an operation section 26. The engine 21 applies pressure to the hydraulic pump 22, which in turn drives the hydraulic motor 23 for the shredding blades and the hydraulic motor 24 for the screw conveyor. This operation is controlled on the operation section 26.

FIG. 3 (a) is a front view of another shredder chamber, FIG. 3 (b) is a side view of the shredder chamber and FIG. 3 (c) is a plan view of the shredder chamber. As shown, the shredder chamber includes hydraulic motors 31, a hydraulic motor 32 for the screw conveyor, an oil tank 33 and an operation section 34. In this case, the vehicle engine applies pressure to the oil pump, which in turn drives the hydraulic motors 31 and 32.

Since the shred storage chamber 7 collects the compressed shreds, the four side walls are coated with reinforcement panels to achieve wall strength. The reinforcement panels may be wood or aluminum. Considering the balance of strength and weight, a wood panel is sufficient. The surface of the reinforcement panel is preferably flat to smoothly discharge the strips of the documents. Since the strips of the documents originally contain a several percent of moisture, a slight amount of moisture is emitted into the space from the cut section of the strips. Condensation may take place on the wall of the shredder chamber. The surface of the panel is thus preferably flat to allow condensation to drop downward smoothly.

The floor of the shred storage chamber 7 may be covered with a sheet of steel. When shreds are discharged, forks of a forklift are inserted below the sheet of steel and pulls the steel sheet together with the shreds thereon for discharging. Alternatively, the entire floor of the loading platform 2 may be a moving floor of conveyor, and the conveyor is driven to discharge the shreds (Reference is made to Japanese Patent 2816140).

The operation of this vehicle thus constructed is described below. Since the vehicle is self-propelled vehicle, the vehicle is dispatched to a location where confidential documents are to be disposed. At each location, the confidential documents are collected and managed. The confidential documents are then conveyed to the shredding operation chamber 5 of the vehicle with a paper shredder 1. An operator successively introduces the confidential documents to the shredder chamber 6 through the paper introduction section 10. The confidential documents are shredded by the two axis shredding blades of the shredder chamber 6 and resulting strips are discharged below the shredding blades, and fall to the conveyance and compaction unit 12. The screw conveyor of the conveyance and compaction unit 12 operates, thereby conveying the strips to the shred storage chamber 7 while compressing the strips at the same time.

The discharge port of the conveyance and compaction unit 12 is located at the level of the floor of the shred storage chamber 7. Conveyed strips are then pushed and distributed over the floor of the shred storage chamber 7. The shredding operation is further continued and newly strips run over the strips already distributed on the entire floor. The strips, already slightly compacted by the conveyance and compaction unit 12, have more weight per volume than merely shredded strips. Strips running on other strips compacts the strips therebelow with the weight thereof. The strips are then continuously under a discharge force from the conveyance and compaction unit 12 and a pressure of weight of thereof. When the shred storage chamber 7 is full of the strips, a substantial compaction force works, compressing the strips into a compact state.

The strips are further compressed under vibration during driving until the vehicle returns home to the paper manufacturing company after completing the shredding operation. Even if the vehicle with a paper shredder is not full, the strips become compact before reaching the paper recycling location. If hinged double doors on the back of the vehicle are opened at the paper recycling location, stacked strips are free from collapsing.

In an unloading operation, the strips are unloaded using a forklift., With forks of the forklift inserted beneath the steel sheet placed on the floor of the shred storage chamber 7, the forklift lifts the steel sheet together with the strips thereon for unloading. If the floor is constructed of the belt conveyor, the strips are discharged by operating the belt conveyor.

Although the invention is shown and described with respect to certain embodiment, it is obvious that equivalents and modifications will occur to those skilled in the art upon reading and understanding the specifications and appended claims. The present invention includes all such equivalents and modifications and is limited only by the scope of the claims:

1. A vehicle with a paper shredder comprising a driver's cab section, a loading platform section and a box-like container mounted on the loading platform defining a closed space, wherein the box-like container is partitioned, from the front to the back of the vehicle, into a shredding operation chamber where an operator works, a shredder chamber into which papers are introduced for shredding, and a shred storage chamber for compacting and collecting the shreds.

2. The vehicle with a paper shredder of claim 1, wherein the shredder chamber comprises a paper introduction port opened to the shredding operation chamber, a shredder arranged below the paper introduction port including two axis shredding screw blades below the paper introduction port and a conveyance and compaction unit including a screw conveyor for conveying shredded strips to the shred storage chamber, the conveyance and compaction unit having a discharge port opened at the level of the floor of the shred storage chamber.

3. The vehicle with a paper shredder of claim 2, wherein a drive shaft of the screw conveyor is tilted up backward at an angle within a range from 0 to 5 degrees with respect to the floor of the shredder chamber.

4. The vehicle with a paper shredder of claim 2, wherein the shredder chamber comprises an engine, the engine applying pressure to a hydraulic pump which drives hydraulic motors for the shredding screw blades and the screw conveyor.

5. The vehicle with a paper shredder of claim 2, wherein an engine of the vehicle applies pressure to a hydraulic pump, thereby driving hydraulic motors for the shredding screw blades and the screw conveyor.

6. The vehicle with a paper shredder of claim 1, wherein at least four internal faces of the shred storage chamber are covered with reinforcement panels having flat surfaces.

7. The vehicle with a paper shredder of claim 1, wherein the floor of the shred storage chamber is covered with a single sheet of steel.

8. The vehicle with a paper shredder of claim 1, wherein the entire floor of the shred storage chamber includes a belt conveyor.
